(19) United States
(12) Patent Application Publication
(10) Pub. No.: US 2009/0053389 A1
(43) Pub. Date: Feb. 26, 2009

(54) Dietary Suppliment fiber composition with calcium and chelating agent

(75) Inventor: Shyam Sundar Vangala, Pine Brook, NJ (US)

Correspondence Address: FRANK A. SMITH;Novartis Consumer Health, Inc., 200 Kimball Drive, OTC PATENT DEPARTMENT - 5TH FLOOR, Parsippany, NJ, 07054-0622, US

(73) Assignee: Novartis AG, Basel (CH)

(21) Appl. No.: 12/229,121

(22) Filed: Aug. 20, 2008

Related U.S. Application Data
(60) Provisional application No. 60/957,473, filed on Aug. 23, 2007.

(51) Int. Cl. A23L 1/30

(52) U.S. Cl. 426/658; 426/665

(57) ABSTRACT

A composition and a method to administer dietary fibers with calcium supplementation are disclosed. The composition combines soluble dietary fibers with a soluble calcium salt and chelating agent to provide an easy to use product which can be mixed with a wide variety of foods or beverages, especially milk and other dairy products.

### SUMMARY OF THE INVENTION

The present invention relates to dietary supplement compositions comprising a water-soluble dietary fiber, at least one soluble calcium salt that provides a source of elemental calcium, and a chelating agent, which are useful for combined fiber and calcium supplementation of an edible article. The compositions of the invention can be rapidly dissolved in water, juice and other beverages without appreciably altering taste, texture or viscosity or changing the clarity or appearance of the liquid. In particular, the compositions may be used to prepare fiber and calcium-fortified milk and other dairy products that are resistant to curdling even at elevated temperatures, and that may be prepared with ease by the consumer. The compositions of the invention may be used for fiber and calcium supplementation of a wide range of edible articles in liquid, solid or semi-solid form, without substantially affecting the organoleptic qualities thereof.

### BACKGROUND OF THE INVENTION

It is well known that dietary fibers are important to maintaining good nutrition. Dietary fibers are associated with several health benefits such as improved heart health, improved immunity, lower cholesterol, weight loss, improved GI health, improved calcium absorption, among many others. While it is recommended by the American Dietetic Association that 25 to 30 grams of dietary fiber be consumed each day, an average American consumer consumes only about half that amount. Consequently, various soluble dietary fibers, such as partially hydrolyzed inulins, resistant maltodextrins and partially hydrolyzed guar gum, have been developed to supplement the diet. For example, BENEFIBER® Powder, a product of Novartis Consumer Health Corp., is a free-flowing, particulate composition comprising soluble wheat dextrin that forms substantially clear solutions in water, is substantially taste free, grit-free and non-thickening, and is compatible with a wide variety of cold and hot beverages such as juices or coffee and tea while also being able to be conveniently added to solid or semi-solid foods.

Calcium is an essential mineral and provides many health benefits, such as bone health and reduced colon cancer. Lack of sufficient calcium in nutrition can lead to osteoporosis which can increase the risk of fracture. Since adequate calcium is often not ingested through regular nutrition, supplementation of the diet with calcium is important. Various calcium tablets and calcium-fortified drinks and food items are commercially available.

In general, high levels of calcium in a liquid, particularly insoluble forms of calcium such as carbonates and phosphates, tend to produce a chalky mouthfeel and may impart astringency or bitter taste. Calcium carbonate may be detected as soapy or lemony and can cause carbon dioxide formation. Calcium phosphate, while bland, imparts a gritty mouthfeel. Thus, it has been a challenge to arrive at a calcium composition that does not materially affect the sensory qualities of the foodstuff to which it is added.

Additionally, it has been a particular challenge to achieve calcium dietary supplement compositions that can be employed directly by the consumer for the fortification of dairy-based products such as milk. Calcium salt addition typically affects the pH of milk, which in turn can result in a destabilization of milk proteins. Thus in industrial processes, calcium supplementation of milk is generally followed by a pH adjustment step carried out for the purpose of restoring the pH of the milk to its normal range (see, e.g., U.S. Pat. Nos. 5,928,691, 6,811,800 and 6,994,877). However, such a process is clearly incompatible with the needs of the consumer. Nor do the industrial processes offer the consumer the flexibility to tailor calcium dosing to individual need.

Although supplements for dietary fibers and calcium are separately available, supplements designed to provide nutritionally sufficient levels of dietary fibers and calcium in combination are not widely available. WO 2007/035431 teaches supplement compositions comprising fiber and organic calcium salts; however, curdling may be experienced when these compositions are added to milk or other beverages at elevated temperatures.

A dietary supplement providing both dietary fiber and calcium, that can be conveniently be added to an edible article by the consumer, and subjected to the usual range of temperatures in the normal consumption of said edible article, would be highly desirable.

### DETAILED DESCRIPTION

It has now been found that a dietary supplement composition that comprises a soluble fiber, at least one soluble calcium salt and, in particular, a chelating agent, may be added to water, or other beverage or a solid or semi-solid food, and especially, dairy products, without sacrificing the stability or sensory qualities of the resulting article. The compositions of the invention form substantially clear and palatable solutions in water, and they are also compatible with a wide variety of beverages, including dairy products such as whole milk, skim milk, and half-and-half, and dairy substitutes such as soy milk, non-dairy creamer, rice milk, almond milk, etc., or coffee and tea containing any of the foregoing, as well as solid or semi-solid foods comprising dairy, such as cereals with milk, or milk-derived products such as yoghurt and ice-cream. Unexpectedly, it has been found that dairy products fortified with the fiber/calcium compositions of the invention retain their palatability and are resistant to curdling not only at room temperature but also at elevated temperatures. Furthermore, the fiber/calcium compositions of the invention when added to dairy products are found to exert a stabilizing effect on the pH, dispensing with the need for pH adjustment; and thus they are well-suited to be self-administered by the consumer.

Soluble fibers suitable for the compositions in general are water-soluble fibers that do not significantly change the viscosity and taste of a foodstuff to which the fiber is added.

The term “soluble fiber” as used herein is in accordance with AACC (American Association of Cereal Chemists) Method 32-07. Suitable dietary fibers, when dissolved in water at room temperature to form a 10 wt % solution, increase the viscosity less than 50 cp (0.05 Pa s), preferably less than 25 cp, and more preferably less than 10 cp.

Suitable fibers include water-soluble inulin, intact or partially hydrolyzed, fructooligosaccharides, galactooligosaccharides, resistant starch and in particular, modified substantially indigestible maltodextrin, as well as partially hydrolyzed guar gum, and mixtures thereof.

Inulin is the common name for certain carbohydrate molecules in which one glucopyranosyl unit is coupled to several fructose units in varying degrees of polymerization with the lower limit being generally recognized as about fructose units, although the degree of polymerization can be as low as 2. The upper limit for water-soluble inulin is usually considered a degree of polymerization of about 60. Water-soluble inulin (hereinafter referred to inulin) is commercially available for example from Cargill, U.S.A, under the brand name OLIGGO-FIBER® (e.g., F-97 and LC/HT inulin), by Sensus America under brand name FRUTAFIT®, and by Orafti under brand name BENEO®.

An inulin powder also suitable for use in the compositions of the invention is marketed by Procter & Gamble under the name, FIBER-SURE®.

Suitable soluble dextrins prepared from wheat or maize starch are available from Roquette Freres under the trade name, NUTRIOSE® (e.g., NUTRIOSE® FB or FM 06 and NUTRIOSE® FB or FM 10) and are described in U.S. Pat. No. 6,630,586, incorporated by reference. Said dextrins have a glycosidic bond distribution as follows: approximately 50% of 1, 4-linkages, approximately 30% of 1, 6-linkages, and approximately 10% each 1,2-and 1,3-glycosidic linkages. For example, NUTRIOSE® FB 06 is a soluble wheat dextrin having a weight average molecular weight of about 5000 and a number average molecular weight of about 2800 g/moie, and a residual content in Dpi (monosaccharides) and Dp2 (disaccharides) of below 0.5%/DS.

Modified maltodextrin dietary fiber suitable for use in the compositions of the invention is also available, for example, from Matsutani Chemical Industries, Japan, under the name FIBERSOL®, and described in U.S. Pat. No. 5,472,732, incorporated by reference.

Partially hydrolyzed guar gum (PHGG) dietary fiber is produced by partially hydrolyzing guar gum to reduce its average molecular weight to around one tenth of unmodified guar gum. Prior to hydrolysis, the molecular weight of guar gum is approximately 200,000, and after hydrolysis, it is typically 15,000 to 35,000, preferably 20,000 to 30,000. The PHGG does not significantly increase the viscosity of water or other aqueous liquid even when the daily recommended amount of the dietary fiber is dissolved in a readily consumable amount of liquid. PHGG is available from Taiyo Int'l as SUNFIBER®. PHGG-containing compositions for medical nutritional supplementation are available from Novartis Consumer Health Medical Nutrition as RESOURCE® BENEFIBER®.

Also suitable for use in the compositions of the invention are arabinogalactans supplied by Lonza Group Ltd., under the brand name FIBERAID®; short chain fructooligosaccharides supplied by GTC Nutrition under the brand name NUTRAFLORA®; polydextroses supplied by Danisco A/S under the brand name LITESSE®, sugar beet fiber by Danisco A/S under the brand name FIBREX®; and low viscosity acacia supplied by CNI Colloides Naturals, Inc. as FIBERGUM™.

It is to be appreciated that one or a combination of soluble dietary fibers can be used and it is within the skill of the art to choose the soluble dietary fiber or mixture as desired.

Of the suitable water-soluble dietary fibers, those preferred in the compositions of the invention are soluble dextrins prepared from wheat or maize starch, especially Nutriose® FB 06 or Nutriose® FB 10.

Such fibers are preferably in the form of free-flowing, pourable compositions. Said compositions may comprise particles consisting essentially of the fiber or aggregates of the fiber with other excipients.

The source of elemental calcium, Ca²⁺, in the compositions of the invention consists of soluble calcium salts that preferably have a water solubility higher than 10 grams per liter (g/l) at room temperature, preferably higher than 30 g/l, more preferably higher than 300 g/l. Additionally, a suitable calcium salt does not impart significant taste properties, e.g., disagreeable taste, to the edible article to which it is added.

Various food grade calcium salts are known and can be used in the present invention. Preferred are organic salts of calcium, examples of which include calcium lactate, calcium gluconate, mixtures of calcium lactate and calcium gluconate (referred to as “calcium lactate gluconate” or “calcium lactogluconate” or “CLG”), calcium fumarate and calcium glycerophosphate. Alternatively, inorganic water-soluble salts such as calcium chloride may also be used.

The term “soluble” when used in connection with the calcium salts of the invention, also refers to calcium salt mixtures that form soluble salts of calcium in solution, an example of which consists of the mixture of calcium hydroxide with an organic acid, such as citric acid or malic acid. While calcium will tend to precipitate (as, e.g., calcium citrate) from such solutions over time, suitable such calcium salts shall be employed in appropriate concentration so that precipitation does not occur within the typical time for consumption of a food product that is supplemented with a composition according to the invention.

Preferred calcium salts include calcium gluconate, calcium lactate, and calcium lactate gluconate (CLG).

CLG is particularly preferred for its high solubility and neutral taste profile. CLG is a mixture of calcium lactate and calcium gluconate having a solubility in water of approximately 400 g/L, which is about five to ten times more soluble than either calcium lactate or calcium gluconate alone. This corresponds to a calcium content of about 45 to 50 g/L, depending on the ratio of the mixture.

Preferably, the CLG has an elemental calcium content between about 10% and about 13%. CLG with calcium content of approximately 13% and water content of approximately 4% is commercially available from Jungbunzlauer. CLG is also available as PURACAL® XPro or XPerform, from Purac Biochem, Netherlands, having elemental calcium content of approximately 12.2-13.2% or 10.0-11.0%, respectively. Both products are characterized by a water content of approximately 5.0-10.0%, with maximum acidity of 0.45% as lactic acid, a pH of a 5% cold solution (20° C.) thereof of 6.0-8.0, and an initial solubility in water of a minimum of 20 g/100 ml at 20° C.

Although it is highly soluble, CLG, either by itself or mixed with a soluble fiber, has been observed to destabilize milk proteins and cause curdling at elevated temperatures. Unexpectedly, it has been found that the addition of a mineral chelating agent to the combination of fiber and soluble calcium salt, prevents milk and other dairy products from destabilizing even at significantly elevated temperatures (e.g., 80-100° C.).

Thus the compositions of the invention also include a chelating agent. In general, such a chelating agent consists of a ligand that has two or more electron donating groups.

Desirable chelating agents are neutral, non-acid compounds that are food grade or otherwise edible. By non-acid, is also meant that the chelator will not significantly alter the pH of the final food composition. Examples of this class include the citric acid salts, tartaric acid salts, malic acid salts, ethylenediaminetetraacetates (EDTAs), metaphosphates, polyphosphates, and pyrophosphates.

Examples of citric acid salts include the alkali metal salts (i.e. sodium, potassium), as well as the calcium, the monoglyceride, the monoisopropyl, the stearyl, and the triethyl salts of citric acid. These include sodium citrate (e.g., sodium citrate monobasic and sodium citrate tribasic dehydrate), potassium citrate (e.g., potassium citrate monobasic, potassium citrate and tribasic), ammonium citrate (e.g., ammonium citrate dibasic), calcium citrate (e.g., calcium citrate tribasic tetrahydrate), magnesium citrate (e.g., magnesium citrate tribasic nonahydrate). Preferred citric acid salts are potassium citrate (e.g., tripotassium citrate monohydrate) and trimagnesium citrate.

Examples of EDTAs are disodium calcium ethylenediaminetetraacetate, and disodium dihydrogen ethylenediaminetetraacetate.

Examples of polyphosphates and pyrophosphates are sodium pyrophosphate, sodium hexametaphosphate, sodium tripolyphosphate,

Examples of suitable tartaric acid salts include ammonium tartrate dibasic, potassium sodium tartrate tetrahydrate, potassium D-tartrate monobasic, sodium bitartrate, and sodium tartrate dibasic dihydrate.

One or a combination of chelating agents can be used in the present invention as desired. The preferred chelating agent is potassium citrate due to its safety, acceptable taste, high solubility, and its ability to dissolve quickly in water or other beverages and good stability. Tripotassium citrate is available, e.g., from Jungbunzlauer or Fisher Scientific.

Preferred compositions of the invention comprise a soluble dietary fiber (such as inulin, PHGG or hydrolyzed dextrin), a soluble organic calcium salt selected from calcium gluconate, calcium lactate, and mixtures thereof (i.e. calcium lactate gluconate); and a soluble citric acid salt as the chelating agent.

Most preferably, the compositions comprise, and may consist essentially of, a soluble wheat or maize dextrin, e.g., NUTRIOSE® 06 or NUTRIOSE® 10 (either FB from wheat or FM from maize), and especially NUTRIOSE® FB 06; a mixture of calcium lactate and calcium gluconate (e.g., CLG supplied by Jungbunzlauer); and potassium citrate (e.g., tripotassium citrate monohydrate).

Whereas it has been observed that introduction of a fiber/CLG composition to cows' milk in the absence of a chelating agent generally lowers the pH of the milk, it has been found that the presence of a chelating agent serves to sufficiently stabilize the pH, so that the pH adjustment step typically required in prior industrial calcium supplementation processes can be omitted. Thus, for example, addition of a fiber/CLG mixture to whole cow's milk, which normally has a pH of about 6.4 to about 6.8, brings the pH of the milk to about 6.2. However, when potassium citrate is included in the mixture, the pH of the milk remains essentially unchanged. Similarly, it has been observed that the pH of skim milk from cows, which normally is about 6.8 to about 7.0, remains essentially stable with addition of fiber and CLG in the presence of potassium citrate. Without intending to be bound thereby, it is believed that the citrate ion, in binding free calcium, prevents the calcium from binding to, and thereby destabilizing and precipitating, the milk proteins. This stabilizing effect has been observed even at elevated temperatures, and is particularly unexpected in view of teachings in the literature that added citrate causes a decrease in the heat stability of milk, see, e.g., J. S. Sindhu and M. Tayal, Food Chemistry 15 (1984) 57-62. Of course, the omission of a pH adjustment step from the preparative process makes it possible for fiber/calcium supplemented dairy products to be prepared by the consumer and self-administered according to an individually tailored regimen.

The compositions of the invention are highly soluble such that a relatively large amount of the composition can be added to and quickly incorporated, essentially sediment-free, into a foodstuff, especially when the foodstuff has high moisture content or is a liquid. For example, if the edible article is an aqueous liquid product, the composition quickly dissolves and blends into the contents of the product without imparting appreciable organoleptic property or taste changes, e.g., viscosity increase or undesirable taste or odor. In general, it is desirable that the composition of the invention be completely solubilized after about one minute of stirring into food and one minute of sitting. Accordingly, the composition can be conveniently used to supplement nutritional values of an edible article without sacrificing its original flavor and organoleptic properties.

The fiber/calcium supplement compositions of the invention may be self-administered by the consumer by adding the composition to a foodstuff (e.g., a beverage or soft food), and consuming the resulting fiber/calcium supplemented foodstuff. Non-carbonated beverages are preferred. Where the compositions of the invention are added to a milk or milk-derived product, the milk may be an animal milk, from mammals such as cows, sheep, goats, water buffalo or camels; or the milk may be of vegetable origin, e.g. soy milk.

Depending upon the supplementation requirements, one can select a composition that provides adequate calcium per serving, such as for example 100, 200 or 300 mg of elemental calcium per serving. More preferably, a serving provides 200 to 300 mg of elemental calcium per serving. One embodiment consists of a composition that provides 200 mg elemental calcium per serving, said composition preferably comprising about 50 to 70 wt % fiber, about 15 to 30 wt % calcium salt, and about 10 to 25 wt % of the chelating compound. Another embodiment consists of a composition that provides 300 mg elemental calcium per serving, said composition preferably comprising about 35 to 45 wt % fiber, 25 to 35 wt % of calcium salt and 20 to 30 wt % of chelating agent. A typical composition comprises about 45 wt % fiber, about 30 wt % calcium salt and about 27 wt % chelating agent, providing about 300 mg elemental calcium per serving in a tablespoon amount of about 8.8 g.

It is to be noted that one can choose different ratios of fiber to calcium salt as required for the supplementation needs and serving sizes, provided that adequate chelating agent is included. Preferably, the molar ratio of chelating agent to elemental calcium in the composition is greater than about 0.35:1 (e.g., within the range of about 0.35:1 to about 1:1); preferably greater than about 0.65:1 (e.g., within the range of about 0.65:1 to about 1:1); alternatively, about 0.5:1 to about 1:1, and most preferably is about 0.75:1 to about 1:1 (e.g., about 0.85:1 to about 1:1), e.g., 0.89:1.

The compositions of the invention may be administered to an adult consumer of 12 years of age or older, as well as to children 6-11 years of age, in an amount of about 1 to 2 level tablespoons, and preferably no more than 1 tablespoon, per day. An illustrative adult regimen consists of 1 level tablespoon added to 4 or 8 ounces (i.e. approximately 120 or 240 ml) (i.e. of a beverage or soft (hot or cold) food, once per day. In one embodiment, 1 tablespoon provides fiber supplementation of about 5-6 g fiber per serving (12% of percent daily values based on a 2,000 calorie diet) and calcium supplementation of about 200 mg elemental calcium per serving. In another embodiment, 1 tablespoon provides fiber supplementation of about 3 g fiber per serving and 300 mg elemental calcium per serving.

The compositions are pourable or freely flowable from a container, making the composition easy to withdraw from a container, for example, by shaking the container or using a spoon. The term “pourable” as used herein indicates that the composition is a particulate, granule or powder composition which is freely flowable and spoonable.

As another preferred embodiment, the composition does not contain significant amounts of other ingredients such that the composition can be applied to an edible composition without imparting any significant taste that can alter the original taste of the edible article. However, the composition may contain a processing aid, e.g., processing lubricant or filler, that does not impart an appreciable extraneous taste profile. It is also desirable for the composition to be devoid of any significant amounts of other components that can increase the caloric content of the article. In this embodiment, the composition is free of other caloric components, e.g., sugar, such that the composition supplements calcium and dietary fiber without increasing the caloric value of the foodstuff.

The present composition can be prepared by mixing a powder form of a dietary fiber and a powder form of an organic calcium salt and the chelating agent. A wet agglomeration process can also be used to produce low density granules of the composition to ensure that the contents of the composition are uniformly intermixed and to provide a delivery form that has increased wetting properties. In general, a wet agglomeration process forms agglomerates by wetting a powder material with a binding agent, e.g., water, while fluid mixing the powder to cause the powder to form wetted and subsequently agglomerated granules. The resulting agglomerates may be screened and/or milled to yield a specific desired particle size. It is to be noted that the agglomerates should not be too large as to hinder its solubility, or too fine as to be to easily dispersed in the air or lack sufficient liquid dispersion properties. It is advantageous for the pourable form of the composition to have sufficient void volume in relation to the weight of the composition to promote quick wetting and subsequent dissolution in an aqueous consumable article, such as beverage or liquid food article.

Agglomerates may have have an average particle size between 100 and 500 micrometers, and a density between 0.25 and 0.41 gram/cubic centimeter, for example between 0.29 and 0.33 gram/cubic centimeter (e.g., between 0.25 and 0.37 gram/cubic centimeter).

The composition also may have a bulk density of between about 0.45 to about 0.7, for example between about 0.5 to about 0.6 g/cc; and a tap density of between about 0.65 to about 0.75, for example about 0.7 g/cc.

The present composition can be added to various food or beverage products, and in particular, dairy products. It can be added to edible products that are clear or transparent since the composition dissolves to clearly and colorlessly incorporate into the edible products. The composition can also be mixed with cooking ingredients, or sprinkled on fully prepared edible articles.

In addition to the dietary fiber and organic calcium, the composition may additionally contain other ingredients. Ingredients that facilitate manufacturing processes, improve aesthetics and organoleptic properties of the composition can be added. These ingredients include stabilizer, colorants, fillers and processing aids, depending on the intended use of the composition. The compositions are desirably free of thickening or gelling additives such as, e.g., carageenan. Depending on the application of the composition, other materials can also be added including flavorants, natural sweeteners, and artificial sweetener. However, natural sweeteners should be avoided if a low caloric supplement is desired. Suitable flavoring agents may be selected from synthetic flavor oils and/or those derived from natural fruits, plants, leaves, flowers, and so forth, and combinations thereof such as citrus oil including lemon, orange, grape, lime and grapefruit and fruit essences including apple, apricot, strawberry, cherry, pineapple and the like. Also useful are flavor oils such as spearmint oil, cinnamon oil, oil of wintergreen (methylsalicylate) and peppermint oils.

The present invention is further illustrated by reference to the following examples, which are intended to be illustrative and not limitative of the scope of the invention.

In the examples, calcium lactate gluconate (CLG) is obtained from Jungbunzlauer or PURACAL; calcium lactate and calcium gluconate are obtained from Jungbunzlauer; tripotassium citrate is obtained from Jungbunzlauer or Fischer Scientific; the soluble dextrin fiber is NUTRIOSE FB 06 (Roquette Freres); the inulin is FIBERSURE®; and the partially hydrolyzed guar gum (PHGG) is obtained from Taiyo Int'l. For purposes of Examples 1-9, the elemental calcium content of the CLG is estimated to be approximately 10% by weight. Unless otherwise specified, the milk is pasteurized cows' milk.

### COMPARATIVE EXAMPLE 1

3 g of CLG is added to 200 ml milk in the absence of a chelating agent. At a temperature of 60-65° C., the milk did not curdle. However, when the milk is heated in a microwave oven to a temperature of 90° C., curdling is seen.

### COMPARATIVE EXAMPLE 2

3 g of CLG and 4 g of soluble dextrin fiber are dry blended and added to milk in the absence of a chelating agent. This composition, when added to 200 ml of milk pre-heated to a temperature of 60-65° C., causes the milk to curdle. The same results are obtained when PHGG or inulin is substituted for the dextrin. Thus, the soluble fibers accentuate the curdling caused by addition of calcium.

### EXAMPLE 3

3 g of CLG and 1.2 g of tripotassium citrate are dry blended and added to 200 ml of milk that has been microwaved for about 2.5 minutes. No curdling is evident. The same experiment without tripotassium citrate results in curdling.

### EXAMPLE 4

2 g each of CLG and tripotassium citrate are dry blended with 4 g of either PHGG or soluble dextrin fiber, and dissolved in about 200 ml of water to provide a clear, virtually taste-free composition.

### COMPARATIVE EXAMPLE 5

2 g of CLG and 4 g of soluble dextrin fiber are dry blended and added, in the absence of a chelating agent, to 200 ml of milk, with stirring. The milk is microwaved for about 90 seconds. Curdling is observed.

### EXAMPLE 6

2 g each of CLG and tripotassium citrate and 4 g of soluble dextrin fiber are dry blended and added to 8 oz. of milk, with stirring. The milk is microwaved for about 90 seconds. Curdling is not observed.

### EXAMPLE 7

2 g of CLG, 540 mg of potassium citrate and 4 g of soluble dextrin fiber are dry blended and added to about 120 ml of either whole or skim milk at 25, 40, 60 or 80° C. No curdling is observed, except in the milk that has been heated to 80° C.

### COMPARATIVE EXAMPLE 8

2 g of CLG and 4 g of inulin are dry blended and added to about 200 ml of hot milk that has been microwaved for about 3 minutes causing the milk to curdle immediately.

### EXAMPLE 9

The experiment of the previous example is repeated except that 2 g of tripotassium citrate is included in the dry blend. When added to the heated milk, the milk does not curdle even after 30 minutes.

### EXAMPLES 10-13

In Examples 10-13, dry blends consisting of soluble dextrin fiber, CLG and tripotassium citrate in varying amounts are prepared as in previous examples, and 3-4 g samples of each blend are added to 120 ml of water, whole milk, and coffee containing whole milk, as indicated in the table below. The amount of elemental calcium and tripotassium citrate salt are calculated for each sample, and are also indicated in the table.

| | Product | | | | | | | | | | |
|---|---|---|---|---|---|---|---|---|---|---|---|
| | (mg elemental | Total | | | | | | | | | |
| | calcium/ | Powder | | | | | | | | | |
| | mg tripotassium | Added | Water | | | Whole milk | | | Coffee | | |
| Ex. | citrate salt) | (g) | RT | 80° C. | 100° C. | RT | 80° C. | 100° C. | RT | 80° C. | 100° C. |
| 10 | 200 mg/ | 3.075 | Clear | Hazy | Hazy | − | − | + | − | − | + |
| | 1080 mg | | | | with ppt. | | | (87° C.) | | | (94° C.) |
| 11 | 200 mg/ | 3.14 | Clear | Hazy | Hazy | − | − | + | − | − | + |
| | 1210 mg | | | | with ppt. | | | (94° C.) | | | (94-96° C.) |
| 12 | 300 mg/ | 3.73 | Clear | Hazy | Hazy | − | − | + | − | − | + |
| | 1620 mg | | | | with ppt. | | | (94° C.) | | | (94-96° C.) |
| 13 | 300 mg/ | 4.00 | Clear | Hazy | Hazy | − | − | − | − | − | − |
| | 2160 mg | | | | with ppt. | | | | | | |

RT = room temperature
“+” indicates that curdling is observed; the temperature at which curdling is first observed is indicated in parenthesis
“−” indicates that no curdling is observed
ppt. = precipitate

Example 13 demonstrates that the addition of 2160 mg of tripotassium citrate overcomes the problem of curdling of the milk and coffee at elevated temperatures up to 100° C. The molar ratio of chelating agent (i.e. citrate) to elemental calcium is approximately 0.89:1 in this Example.

### EXAMPLES 14-18

4.18 g of the dry blend of Example 13 (Composition “A”) and 3.04 g of a dry blend obtained by combining 3 gm of soluble dextrin fiber and 300 mg elemental calcium as CLG (Composition “B”), are added, respectively, to 120 ml of each of water, skim milk, whole milk, coffee (with whole milk) and tea (with whole milk) at room temperature or pre-heated to 80° C. The pH is taken and the following observations recorded:

| | | | | | | | | | pH of | |
|---|---|---|---|---|---|---|---|---|---|---|
| | | | pH of | | | | | | beverage | |
| | | | beverage | | Curdling | | Curdling | | with | |
| | | pH of | with Sample | | at RT | | at 80° C. | | Composition | |
| | | beverage | at RT | | (+/−) | | (+/−) | | at 80° C. | |
| Ex. | Beverage | at RT | (A) | (B) | (A) | (B) | (A) | (B) | (A) | (B) |
| 14 | water | 7.43 | 7.57 | 7.04 | N/A | N/A | N/A | N/A | 7.36 | 6.89 |
| 15 | skim milk | 6.96 | 6.95 | 6.37 | − | − | − | + | 6.78 | 6.00 |
| 16 | whole | 6.58 | 6.62 | 6.25 | − | − | − | + | 6.38 | 5.79 |
| | milk | | | | | | | | | |
| 17 | coffee | 6.29 | 6.39 | 6.02 | − | − | − | + | 6.27 | 5.70 |
| | w/milk | | | | | | | | | |
| 18 | tea w/milk | 6.62 | 6.60 | 6.16 | − | − | − | + | 6.49 | 5.89 |

“+” indicates that curdling is observed; the temperature at which curdling is first observed is indicated in parenthesis
“−” indicates that no curdling is observed

A comparison of the results for Compositions “A” and “B” indicates that the presence of tripotassium citrate as a chelating agent is necessary to protect the milk from curdling at 80° C.

### EXAMPLES 19-23

4.05 g of a dry blend comprising 3 g of soluble dextrin fiber, 300 mg of elemental calcium as calcium lactate and 2.16 g of tripotassium citrate (Composition “C”) and 4.62 g of a dry blend comprising 3 g of soluble dextrin fiber, 300 mg of elemental calcium as calcium gluconate and 2.16 g of tripotassium citrate (Composition “D”), are added, respectively, to 120 ml of each of water, skim milk, whole milk, coffee (with whole milk) or tea (with whole milk) at room temperature or pre-heated to 80° C. The pH is taken and the following observations recorded:

| | | | | | | | | | pH of | |
|---|---|---|---|---|---|---|---|---|---|---|
| | | | pH of | | | | | | beverage | |
| | | | beverage | | Curdling | | Curdling | | with | |
| | | pH of | with Sample | | at RT | | at 80° C. | | Composition | |
| | | beverage | at RT | | (+/−) | | (+/−) | | at 80° C. | |
| Ex. | Beverage | at RT | (C) | (D) | (C) | (D) | (C) | (D) | (C) | (D) |
| 19 | Water | 6.35 | 7.59 | 7.61 | N/A | N/A | N/A | N/A | 7.33 | 7.50 |
| 20 | skim milk | 6.99 | 6.85 | 7.02 | − | − | −¹ | −² | 6.83 | 6.96 |
| 21 | whole | 6.44 | 6.50 | 6.58 | − | − | − | + | 6.48 | 6.51 |
| | milk | | | | | | | | | |
| 22 | coffee | 6.22 | 6.38 | 6.47 | − | − | − | + | 6.32 | 6.38 |
| | w/milk | | | | | | | | | |
| 23 | tea w/milk | 6.60 | 6.57 | 6.69 | − | − | − | + | 6.58 | 6.55 |

“+” indicates that curdling is observed; the temperature at which curdling is first observed is indicated in parenthesis
“−” indicates that no curdling is observed
¹water became turbid, some precipitation observed.
²water became hazy

Compositions “C” and “D” are shown to prevent curdling at 80° C.

### EXAMPLE 24

One serving of a composition of the invention is taken in a level tablespoon, and consists of 3.88 g of soluble dextrin fiber, 1.77 g CLG, and 1.54 g tripotassium citrate. The composition is added to 240 ml of each of whole milk, skim milk, coffee, and tea at temperatures of up to 100° C., without evidence of curdling. The serving contains approximately 3 g fiber and 200 mg elemental calcium.

### EXAMPLE 25

One serving of a composition of the invention, consisting of 3.88 g of soluble dextrin fiber, 2.66 g CLG and 2.29 g tripotassium citrate, is added to 240 ml of each of whole milk, skim milk, coffee and tea at temperatures up to 100° C., without evidence of curdling. The serving contains approximately 3 g fiber and 300 mg elemental calcium.

### EXAMPLE 26

One serving of a composition of the invention is taken in a level tablespoon, and consists of 5.5 g of soluble dextrin fiber, 1.77 g CLG and 1.54 g tripotassium citrate. The composition is added to 240 ml of each of whole milk, skim milk, coffee, and tea at temperatures of up to 100° C., without evidence of curdling. The serving contains approximately 4.25 g fiber and 200 mg elemental calcium.

What is claimed is:

1. A dietary composition comprising a soluble dietary fiber, at least one soluble calcium salt, and a chelating agent.

2. A dietary composition according to claim 1 wherein the calcium salt comprises calcium lactate gluconate.

3. A dietary composition according to claim 2 wherein the chelating agent comprises potassium citrate.

4. A dietary composition according to claim 2 wherein the water-soluble fiber is selected from the group consisting of inulin, soluble dextrin, and partially hydrolyzed guar gum.

5. A dietary composition according to claim 3 wherein the water-soluble fiber is a soluble dextrin prepared from wheat or maize starch.

6. A dietary composition according to claim 3 wherein the water-soluble fiber is partially hydrolyzed guar gum.

7. A dietary composition according to claim 5 wherein the water-soluble fiber is inulin.

8. A method of preparing a fiber and calcium-supplemented edible article comprising adding to the article a dietary composition according to claim 1.

9. A method according to claim 8 wherein the edible article is milk or a milk-derived substance.

10. A fiber and calcium-supplemented edible article comprising a dietary composition according to claim 1.

11. A fiber and calcium-supplemented edible article according to claim 10 which is water.

12. A fiber and calcium-supplemented edible article according to claim 10 which is milk.
